(19) United States
(12) Patent Application Publication
(10) Pub. No.: US 2026/0087362 A1
(43) Pub. Date: Mar. 26, 2026

(54) SYSTEM AND METHOD FOR DETECTING CYCLES IN PROJECTED GRADIENT DESCENT FOR ADVERSARIAL ATTACK

(71) Applicant: Booz Allen Hamilton Inc., McLean, VA (US)

(72) Inventors: Philip Doldo, Watertown, NY (US); Derek Everett, Columbia, MD (US); Amol Khanna, Nashua, NH (US); Andre T. Nguyen, McLean, VA (US); Edward Raff, Jamesville, NY (US)

(73) Assignee: Booz Allen Hamilton Inc., McLean, VA (US)

(21) Appl. No.: 18/891,749

(22) Filed: Sep. 20, 2024

(51) Int. Cl. G06N 3/094

(52) U.S. Cl. CPC G06N 3/094

(57) ABSTRACT

Provided are systems, methods, and computer program products for detecting cycles in adversarial attack of a data element including memory configured to include storage locations to store data elements and perturbation data and a processor configured with an adversarial attack module. The processor is configured with program code that, when executed, will cause the processor to iteratively execute generating a perturbed data element by applying a data perturbation with a projected gradient descent algorithm on at least one data element, extracting the data perturbation from the perturbed data element as perturbation data, determining whether the perturbation data is present in the memory, and when the perturbation data is not present in the memory, storing the perturbation data in the memory, and terminating the iterative execution upon confirming that the perturbation data is present in the memory.

### FIELD

The subject matter disclosed relates generally to computer implementations of projected gradient descent (PGD) and adversarial attack of machine learning model inputs, and, in some embodiments, to methods, systems, and non-transitory computer readable mediums encoded with program code for detecting cycles in PGD for adversarial attack of a data element.

### BACKGROUND INFORMATION

Typically, adversarial attack on data elements is computationally demanding. A current best-practice for adversarial attack is to use thousands or more iterations to generate an adversarial example. Many of the iterations used to generate an adversarial example are not needed and are a wasteful use of computational resources and time. Using thousands of iterations for an adversarial attack of a data element may lead to an exact same adversarial example as using significantly less iterations.

### SUMMARY

Embodiments may relate to a computing system for detecting cycles in adversarial attack of a data element. The computing system may include memory configured to include storage locations to store data elements and data associated with perturbations. The computing system may include a processor configured with an adversarial attack module. The processor may be configured with program code that, when executed, will cause the processor to iteratively execute a function of generating a perturbed data element. The processor may generate the perturbed data element by applying a data perturbation with a PGD algorithm on at least one data element. The processor may be configured with program code that will cause the processor to iteratively execute a function of extracting the data perturbation from the perturbed data element as perturbation data. The processor may be configured with program code that will cause the processor to iteratively execute a function of determining whether the perturbation data is present in the memory. When the perturbation data is not present in the memory, the processor may be configured with program code that will cause the processor to iteratively execute a function of storing the perturbation data in the memory. The processor may be configured with program code that will cause the processor to execute a function of terminating the iterative execution upon confirming that the perturbation data is present in the memory.

Embodiments may relate to a computing system for detecting cycles in adversarial attack of a data element. The computing system may include memory configured to include storage locations to store data elements and data associated with perturbations. The computing system may also include a processor configured with an adversarial attack module. The processor may be configured with program code that, when executed, will cause the processor to iteratively execute a function of generating a perturbed data element. The processor may generate the perturbed data element by applying a data perturbation with a projected gradient descent algorithm on at least one data element. The perturbed data element may have a predetermined data label. The processor may be configured with program code that will cause the processor to iteratively execute a function of inputting the perturbed data element to at least one trained machine learning model to generate an output data label. The processor may be configured with program code that will cause the processor to iteratively execute a function of comparing the output data label to the predetermined data label. The processor may be configured with program code that will cause the processor to execute a function of terminating iterative execution upon confirming that the output data label does not match the predetermined data label.

Embodiments may relate to a computer-implemented method for detecting cycles in adversarial attack of a data element. The method may include iteratively executing, with a processor, a function of generating a perturbed data element by applying a projected gradient descent algorithm to at least one data element. The projected gradient descent algorithm may attack the at least one data element by applying a perturbation to the at least one data element. The method may include iteratively executing, with a processor, a function of inputting the perturbed data element to at least one trained machine learning model to generate an output data label. The perturbed data element may have a predetermined data label. The method may include iteratively executing, with a processor, a function of comparing the output data label with the predetermined data label. The method may include iteratively executing, with a processor, a function of extracting the perturbation from the perturbed data element as perturbation data. The method may include iteratively executing, with a processor, a function of reading data entries of perturbation data in the memory. When the perturbation data is not stored in the memory and the output data label matches the predetermined data label, the method may include iteratively executing, with a processor, a function of storing the perturbation data in the memory and continuing the iterative execution. When the data associated with perturbations is stored in the memory or the output data label does not match the predetermined data label, the method may include a function performed by a processor of determining a cycle has occurred and terminating the iterative execution.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for detecting cycles in adversarial attack of a data element as disclosed herein;

FIG. 2 is a flow diagram of an exemplary method for detecting cycles in adversarial attack of a data element based on storing perturbation data in memory as disclosed herein;

FIG. 3 is a diagram of an exemplary method for detecting cycles in adversarial attack of a data element based on determining whether a machine learning model is tricked by a perturbed data element as disclosed herein;

FIG. 4 is a diagram of a data element undergoing adversarial attack with at least one cycle occurring as disclosed herein;

FIG. 5 is a diagram of a two dimensional example of a visualization of a cycle of two iterations occurring on a boundary of an L_{∞} ball as disclosed herein;

FIG. 6 is an exemplary graph displaying a value of a cosine similarity between successive signed gradients for iterations of a PGD algorithm as disclosed herein;

FIG. 7 is an exemplary graph displaying a value of a cosine similarity between every other signed gradient for iterations of a PGD algorithm as disclosed herein;

FIG. 8 is a diagram of an exemplary system environment for detecting cycles in adversarial attack of a data element as disclosed herein; and

FIG. 9 is a diagram of exemplary components of a computing device and/or system as disclosed herein.

### DETAILED DESCRIPTION

In accordance with exemplary embodiments, computing systems having specially configured processors may be used for detecting cycles of a PGD algorithm applied to data elements for adversarially attacking the data element. According to some embodiments, computing systems with a specially configured processor for detecting cycles of a PGD algorithm may reduce computational resources required for applying a PGD algorithm to a data element. For example, embodiments may reduce the number of iterations of a PGD algorithm applied to a data element required to generate a perturbed data element via adversarial attack. Such embodiments may terminate the PGD algorithm early by detecting a cycle in the PGD algorithm using a specially configured processor as disclosed herein. Embodiments terminating a PGD early may provide an exact same data perturbation to a data element that may be applied when applying the PGD algorithm to the data element and allowing the PGD algorithm to execute a large number of iterations (e.g., greater than 1000 iterations). Thus, embodiments of a specially configured processor and a computing system as disclosed herein may reduce an amount of computing resources required and an amount of time required to apply a data perturbation to a data element with a PGD algorithm.

In this way, embodiments providing a reduction in computing resources and a reduction in time required for generating perturbed data elements may allow for more efficient generation and application of perturbed data elements. More efficient generation and application of perturbed data elements may allow for improved evaluation of adversarial robustness of machine learning models, more efficient testing of adversarial attack on machine learning models, and other improvements relating to machine learning models that may be safety-critical. For example, embodiments implementing an iterative PGD algorithm may allow for identifying, via cycle detection, whether the PGD algorithm has failed to generate a perturbed data element that will cause a machine learning model to misclassify the perturbed data element much before an iteration ceiling is reached for the PGD algorithm. Thus, embodiments using a specially configured processor may terminate attacking a data element using the PGD algorithm where additional iterations of the PGD algorithm may never generate a perturbed data element that would cause a machine learning model to misclassify the perturbed data element (e.g., via a machine learning classification task).

Thus, embodiments of computing systems having a specially configured processor as disclosed herein may reduce a number of computations required by a PGD algorithm by up to 96% in some machine learning model applications. By detecting when a cycle occurs in a PGD algorithm, embodiments may terminate the PGD algorithm early while still providing an exact perturbed data element that would be provided if the PGD algorithm is carried out through all iterations. Therefore, such embodiments not only improve upon methods of adversarial attack of data elements, but also reduce needless computation and wasted computing resources.

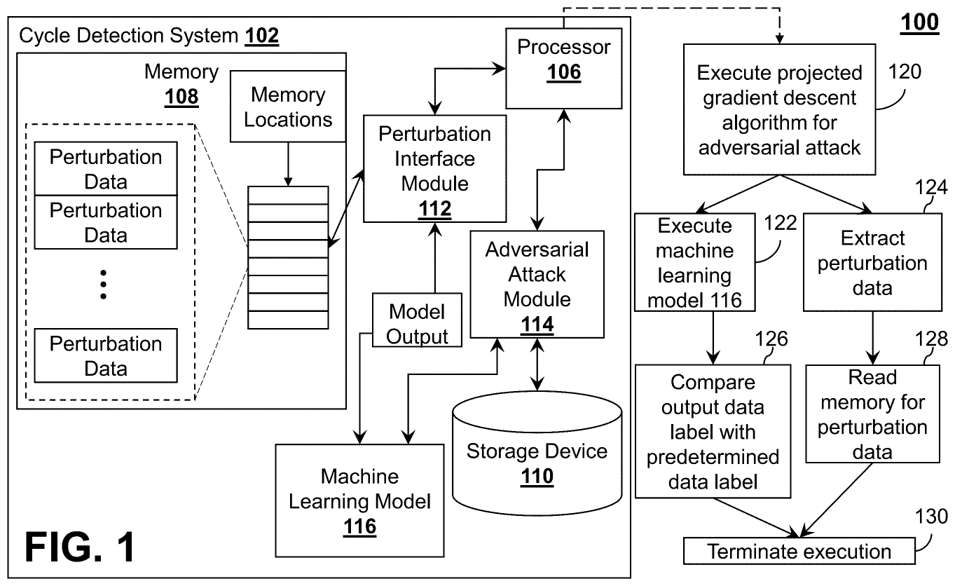

FIG. 1 shows a diagram of an exemplary system configuration for detecting cycles in adversarial attack of a data element as disclosed herein. The various components of FIG. 1 may be implemented in and/or processed by a specially configured processor (e.g., a CPU) and/or on any number of specially configured distributed processors (e.g., a distributed and/or decentralized computing system) coupled with memory and connected via a communications network. Each of the components shown in FIG. 1 are described in the context of an exemplary embodiment.

As shown in FIG. 1, embodiments relate to a computing system 100 configured for detecting cycles in adversarial attack of a data element. In some embodiments, computing system 100 may be specially configured for detecting cycles in adversarial attack of a data element within a computing network. Computing system 100 may include cycle detection system 102, processor 106, memory 108, storage device 110, perturbation interface module 112, adversarial attack module 114, and machine learning model 116. Computing system 100 may execute various functions, for example, functions 120-130 as shown in FIG. 1.

Computing system 100 may be configured for detecting cycles in adversarial attack of a data element using a PGD algorithm. Computing system 100 may include memory 108 including storage locations configured to store data elements and/or perturbation data. Computing system 100 may include model storage device 110 configured for storing machine learning models, data elements and/or perturbation data. Computing system 100 may include processor 106 configured with perturbation interface module 112 and adversarial attack module 114. Processor 106 may be specially configured to execute program code that, when executed, may cause processor 106 to execute perturbation interface module 112 and adversarial attack module 114. Execution of perturbation interface module 112 and adversarial attack module 114 may configure processor 106 to perform various functions. For example, perturbation interface module 112 and/or adversarial attack module 114 may configure processor 106 to execute a PGD algorithm for adversarial attack as shown by function 120. Perturbation interface module 112 and/or adversarial attack module 114 may configure processor 106 to execute machine learning model 116 as shown by function 122. Perturbation interface module 112 and/or adversarial attack module 114 may configure processor 106 to extract perturbation data from a perturbed data element as shown by function 124. Perturbation interface module 112 and/or adversarial attack module 114 may configure processor 106 to compare an output data label from machine learning model 116 with a predetermined data label of a data element as shown by function 126. Perturbation interface module 112 and/or adversarial attack module 114 may configure processor 106 to read memory 108 for perturbation data as shown by function 128. Perturbation interface module 112 and/or adversarial attack module 114 may configure processor 106 to terminate iterations of execution as shown by function 130. In some embodiments, perturbation interface module 112 and/or adversarial attack module 114 may configure processor 106 to execute other functions not shown in FIG. 1. Execution of perturbation interface module 112 and/or adversarial attack module 114 may configure processor 106 to iteratively execute various functions, such as iteratively executing a PGD algorithm.

Execution of perturbation interface module 112 and/or adversarial attack module 114 may configure processor 106 to generate a perturbed data element. For example, processor 106 may apply a data perturbation to at least one data element by using a PGD algorithm on the at least one data element. In some embodiments, a data element may include a single data element or a collection of plural smaller data elements. For example, a data element may include an image (e.g., including pixel data). In some embodiments, a data element may include an image pixel. A data element may also include other data files, such as audio files, video files, time series datasets, or other types of data. In some embodiments, processor 106 may be configured to iteratively generate new perturbed data elements by iteratively applying data perturbations to a data element with a PGD algorithm. Thus, in some embodiments, a data element may include a perturbed data element from a previous iteration, such that the perturbed data element from a previous iteration may be further perturbed by applying the PGD algorithm at a current iteration.

In some embodiments, a data perturbation may include data representing an adversarial attack to at least one data element. For example, a data perturbation may include a brightness value of a pixel which may be applied to a pixel to adversarially attack (e.g., alter) a brightness parameter of the pixel. In some embodiments, data perturbations may be applied to an image, such that plural pixels in an image are adversarially attacked. Data perturbations may include other data and/or data values used to adversarially attack (e.g., alter) at least one data element. With regard to a data element that includes an image, other data perturbations may include color values pixels, pixel locations within the image, replacing the pixel with a different pixel, or other data and/or data values representing noise and/or alterations for adversarially attacking the image.

In some embodiments, a perturbed data element may include at least one data element that has had a data perturbation applied to the at least one data element. For example, a perturbed data element may include an image that has had a data perturbation applied to at least one pixel of the image. A perturbed data element may include other data objects that have been adversarially attacked via a data perturbation (e.g., an audio file, a video file, time series data, and/or the like).

Execution of perturbation interface module 112 and adversarial attack module 114 may configure processor 106 to extract the data perturbation from the perturbed data element as perturbation data. For example, processor 106 may be configured to extract a data perturbation from a perturbed image file as perturbation data, such that the perturbation data can be copied and/or stored separately form the perturbed image file. In some embodiments, perturbation data may include a tensor representing the data perturbation that is applied to the data element to generate the perturbed data element. As disclosed herein, perturbation data may be referred to and/or represented as 8. In some embodiments, processor 106 may be configured to iteratively extract the data perturbation from the perturbed data element as perturbation data. For example, processor 106 may be configured to iteratively extract the data perturbation from the perturbed data element after each iteration where a new perturbed data element is generated via an iteration of a PGD algorithm (e.g., for each new perturbed data element at each iteration).

Execution of perturbation interface module 112 and adversarial attack module 114 may configure processor 106 to determine whether the perturbation data is present in the memory. For example, processor 106 may be configured to read memory 108 and compare the perturbation data to memory locations in memory 108 storing additional perturbation data to determine whether the perturbation data is stored in memory 108. In some embodiments, processor 106 may be configured to iteratively determine whether the perturbation data is present in the memory. For example, processor 106 may be configured to iteratively determine whether the perturbation data is present in the memory after each iteration where the data perturbation is extracted from a new perturbed data element (e.g., for each new perturbed data element at each iteration). In some embodiments, a number of iterations for the iterative execution may include a maximum iteration value. Processor 106 may automatically terminate the iterative execution when the maximum iteration value of the iterative execution is performed by the processor. In this way, a maximum number of iterations may be reached in the PGD algorithm, where cycle detection system 102 may have not detected a cycle such that that iterative execution was not terminated early.

Execution of perturbation interface module 112 and adversarial attack module 114 may configure processor 106 to store the perturbation data in memory when the perturbation data is not present in the memory. For example, processor 106 may be configured to store the perturbation data in memory 108 if, upon reading memory locations of memory 108, processor 106 determines that the perturbation data is not stored in memory 108. Alternatively, if processor 106 reads the perturbation data (e.g., a copy of the perturbation data) stored in memory 108, processor 106 may not store the perturbation data in memory 108 and may discard (e.g., delete) the perturbation data (e.g., a copy of the perturbation data that was extracted from the perturbed data element) instead of storing the perturbation data in memory 108. In some embodiments, the perturbation data may be stored in memory 108 as a tensor δ. In some embodiments, the perturbation data may be stored in memory 108 as a hash of the perturbation data or a hash of a tensor representing the perturbation data. In some embodiments, processor 106 may be configured to iteratively store the perturbation data in memory 108. For example, processor 106 may be configured to iteratively store the perturbation data from new perturbed data elements after each iteration where the data perturbation is determined to not be present in memory 108 (e.g., for each new perturbed data element at each iteration). In some embodiments, once processor 106 discards the perturbation data instead of storing the perturbation data, processor 106 may proceed to generate a new perturbed data element by proceeding to a next iteration.

Execution of perturbation interface module 112 and adversarial attack module 114 may configure processor 106 to terminate the iterative execution upon confirming that the perturbation data is present in the memory. For example, processor 106 may be configured to terminate iterative execution of generating a perturbed data element, extracting the data perturbation, determining whether the perturbation data is present in memory 108, and storing the perturbation data in memory 108. Once processor 106 terminates iterative execution, execution of a PGD algorithm may also be terminated. In this way, processor 106 may be specially configured with perturbation interface module 112 and adversarial attack module 114 to detect a cycle in a PGD algorithm and terminate execution of the PGD algorithm and adversarial attack of a data element. Such early termination of the PGD algorithm may eliminate needless iterations of adversarial attack and may reduce computational time and resources required to adversarially attack data elements.

In some embodiments, cycle detection system 102 may be implemented in a single computing device. Cycle detection system 102 may be implemented in one or more computing devices (e.g., a group of servers, such as a group of computing devices, and/or the like) as a distributed and/or decentralized system such that software instructions, perturbation interface module 112, adversarial attack module 114, and/or machine learning models 116 are implemented on different computing devices. In some embodiments, cycle detection system 102 may be associated with a local computing device, such that cycle detection system 102 is executed on the local computing device or part of cycle detection system 102 is executed on the local computing device as part of a distributed and/or decentralized computing system. Alternatively, cycle detection system 102 may include at least one local computing device executing software instructions for detecting cycles in adversarial attack of a data element.

Cycle detection system 102 may include processor 106, memory 108, storage device 110, perturbation interface module 112, adversarial attack module 114, and machine learning model 116. In some embodiments, cycle detection system 102 may include at least one machine learning model 116 (e.g., stored in model storage device 110). Cycle detection system 102 may include a computing device connected to a network. In some embodiments, cycle detection system 102 may include components shown in FIG. 1 in a single computing device or computing system. Alternatively, cycle detection system 102 may include components shown in FIG. 1 distributed across multiple computing devices and/or computing systems.

Cycle detection system 102 may include processor 106 (e.g., a specially configured processor, CPU, and/or the like), memory 108, and storage device 110. Processor 106 may execute software instructions (e.g., compiled program code) for cycle detection system 102, including software instructions for executing perturbation interface module 112 and adversarial attack module 114.

In some embodiments, perturbation interface module 112 and adversarial attack module 114 may cause processor 106 to generate a perturbed data element by applying a PGD algorithm to at least one data element, extract data perturbations from a perturbed data element as perturbation data and store the perturbation data in memory 108. Perturbation interface module 112 and adversarial attack module 114 may cause processor 106 to execute machine learning model 116 and input the perturbed data element into machine learning model 116 to generate an output data label.

Cycle detection system 102 may include one or more computing devices including one or more processors (e.g., processor 106) configured to execute software instructions. For example, cycle detection system 102 may include a desktop computer, a portable computer (e.g., laptop computer, tablet computer), a workstation, a mobile device (e.g., smartphone, cellular phone, personal digital assistant, wearable device), a server, and/or other like devices. Cycle detection system 102 may include a computing device configured to communicate with one or more other computing devices over a network. Cycle detection system 102 may include a group of computing devices (e.g., a group of servers) and/or other like devices. In some embodiments, cycle detection system 102 may include a data storage device (e.g., storage device 110). Alternatively, a data storage device may be separate from cycle detection system 102 and may be in communication with cycle detection system 102.

Processor 106 may be implemented in hardware, software, or a combination of hardware and software. For example, processor 106 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Processor 106 may be coupled to memory 108 via a data bus to transfer data between processor 106 and memory 108.

Memory 108 may include random access memory (RAM), read-only memory (ROM), and/or another type of dynamic or static storage device (e.g., flash memory, magnetic memory, optical memory, etc.) that stores information and/or software instructions for use by processor 106. Memory 108 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices. In some embodiments, memory 108 may include one or more storage locations for storing data and/or data entries, such as perturbation data.

Software instructions may be read into memory 108 from another computer-readable medium or from another device via a communication interface with cycle detection system 102. When executed, software instructions stored in memory 108 may cause processor 106 to perform one or more processes and/or functions described herein. Embodiments described herein are not limited to any specific combination of hardware circuitry and software and may include various combinations of hardware circuitry and software.

Storage device 110 may include random access memory (RAM), read only memory (ROM), and/or another type of dynamic or static storage device (e.g., flash memory, magnetic memory, optical memory, etc.) that stores information for use by cycle detection system 102 and/or processor 106. For example, storage device 110 may store one or more machine learning models 116. Storage device 110 may store machine learning models 116. In some embodiments, storage device 110 may store data elements, perturbed data elements, and/or perturbation data. In some embodiments, storage device 110 may include a non-transitory computer readable medium that may store information, software, and/or machine learning models related to the operation and use of cycle detection system 102 and/or processor 106. For example, storage device 110 may include a hard disk (e.g., a magnetic disk, an optical disk, a magneto-optic disk, a solid-state disk, etc.) and/or another type of computer-readable medium. In some embodiments, cycle detection system 102 may transmit information to and/or receive information from processor 106.

Storage device 110 may include a computing device (e.g., a database device) configured to communicate with processor 106 (e.g., via adversarial attack module 114) via a bus or a network environment. For example, storage device 110 may include a server, a group of servers, and/or other like devices. In some embodiments, storage device 110 may be associated with one or more computing devices providing interfaces such that a user may interact with storage device 110 via the one or more computing devices. Storage device 110 may be in communication with cycle detection system 102 and/or processor 106 such that storage device 110 is separate from cycle detection system 102 and/or processor 106. Alternatively, storage device 110 may be part (e.g., a component) of cycle detection system 102 (e.g., as shown in FIG. 1).

In some embodiments, storage device 110 may include a device capable of storing data (e.g., a database). In some embodiments, storage device 110 may include a collection of data (e.g., data elements, perturbed data elements, and/or perturbation data) stored and accessed by one or more computing devices. Storage device 110 may include file system storage, cloud storage, in-memory storage, and/or the like. Storage device 110 may include non-volatile storage (e.g., flash memory, magnetic media), volatile storage (e.g., random access memory (RAM)), or both non-volatile and volatile storage. In some embodiments, storage device 110 may be hosted (e.g., stored and permitted to be accessed by other computing devices via a network environment) on a computing device separate from cycle detection system 102. Storage device 110 may be configured to communicate with processor 106 via adversarial attack module 114.

As used herein, a module (e.g., software module, software/hardware module, and/or the like) or a service (e.g., software service, microservice, and/or the like) may refer to a loosely-coupled software application and/or a loosely-coupled software service that is designed to facilitate software reuse and high cohesion. In the microservice architecture, software services are fine-grained and protocols are generally lightweight. Software modules and/or services may include interfaces which are treated as a public application programming interface (API). The software module and/or software service may exist and may be reusable (e.g., portable to other software applications and/or systems without requiring changes to the module) independent of other software modules and/or software services.

Perturbation interface module 112 may include a component (e.g., programmed hardware component, software component) for interfacing processor 106 with memory 108. For example, perturbation interface module 112 may allow processor 106 to interface with memory 108 such that processor 106 may store and/or retrieve objects and/or data in memory 108 (e.g., data elements, perturbed data elements, perturbation data, and/or the like). In some embodiments, perturbation interface module 112 may include a software module (e.g., a module invoked by processor 106 based on program code executed by processor 106) such that functionalities of perturbation interface module 112 may be accessed via an API. In some embodiments, perturbation interface module 112 may include a software module such that perturbation interface module 112 may be packaged into a single unit (e.g., a single unit of reusable program code) that may be easily deployed and/or shared. In some embodiments, perturbation interface module 112 may include a combination of hardware and software (e.g., a specially configured processor to perform certain functions) such that perturbation interface module 112 may perform functions and share data and/or commands with processor 106. Perturbation interface module 112 may include various functions (e.g., via hardware or software) that may cause processor 106 to interface with memory 108 to manipulate objects and/or data (e.g., data elements, perturbed data elements, perturbation data, and/or the like).

As an example, perturbation interface module 112 may be configured to retrieve and/or read data elements, perturbed data elements and/or perturbation data from memory 108. Perturbation interface module 112 may be configured to extract data perturbations from perturbed data elements to create (e.g., via copying, data formatting, and/or the like) perturbation data. Perturbation interface module 112 may read memory 108 to determine whether perturbation data is present and/or was previously stored in memory 108 and perturbation interface module 112 may store perturbation data in memory 108.

In some embodiments, perturbation interface module 112 may allocate memory 108 (e.g., memory locations and/or memory blocks of memory 108) for storing data elements, perturbed data elements, perturbation data, output data labels, and/or predetermined data labels. In some embodiments, perturbation interface module 112 may be configured to initialize data elements, perturbed data elements, perturbation data, output data labels, and/or predetermined data labels. Output data labels may include an output of machine learning model 116 based on providing a perturbed data element as input to machine learning model 116. A predetermined data label may include a label for a data element assigned to the data element manually or a predetermined data label may include an output of machine learning model 116 base don providing a data element as input to machine learning model 116. In some embodiments, perturbation interface module 112 may be configured to store perturbation data in a first storage location in memory 108. In some embodiments, perturbation interface module 112 may be configured to store perturbation data as a tensor δ. Alternatively, perturbation interface module 112 may be configured to store perturbation data as a hash of a tensor δ.

In some embodiments, perturbation interface module 112 may be configured to cause processor 106 to extract a data perturbation from a perturbed data element to generate perturbation data. For example, perturbation interface module 112 may extract a data perturbation from a perturbed data element as perturbation data and perturbation interface module 112 may transmit the perturbation data to processor 106 for processing, to memory 108 for storage, and/or to storage device 110 for storage. In some embodiments, perturbation interface module 112 may configure processor 106 to retrieve perturbation data, data elements, perturbed data elements, output data labels, and/or predetermined data labels from memory 108.

As disclosed herein, a module may include software, hardware, or a combination of software and hardware. As an example, where perturbation interface module 112 includes a software module, perturbation interface module 112 may be configured as program code to cause processor 106 to perform various functions. Alternatively, where perturbation interface module 112 includes software and hardware, perturbation interface module 112 may be configured as program code and hardware (e.g., a specially configured processor) to perform various functions independent of and/or in conjunction with processor 106. In this way, perturbation interface module 112 may be configured with its own hardware and/or processor for performing various functions and perturbation interface module 112 may be integrated with cycle detection system 102 and/or processor 106.

Adversarial attack module 114 may include a component for interfacing processor 106 with storage device 110. For example, adversarial attack module 114 may allow processor 106 to interface with storage device 110 such that processor 106 may store and/or retrieve objects in storage device 110 (e.g., machine learning model 116, data elements, perturbed data elements, perturbation data, etc.). In some embodiments, adversarial attack module 114 may include a component for adversarially attacking at least one data element (e.g., using a PGD, etc.). In some embodiments, adversarial attack module 114 may allow for data elements and/or perturbed data elements to be stored within storage device 110. For example, adversarial attack module 114 may be configured to cause processor 106 to retrieve data elements and/or perturbed data elements stored in storage device 110 local to cycle detection system 102 and/or storage device 110 available within a network in which cycle detection system 102 is connected. Adversarial attack module 114 may be configured to cause processor 106 to store the retrieved data elements and/or perturbed data elements in storage device 110 for later use. Adversarial attack module 114 may be configured to cause processor 106 to interface with storage device 110 to retrieve previously stored data elements and/or perturbed data elements and adversarial attack module 114 may be configured to cause processor 106 to assign and/or associate a predetermined data label with a data element and/or an output data label (e.g., output data label generated by machine learning model 116) with a perturbed data element for storage in memory 108 and/or storage device 110. Additionally, adversarial attack module 114 may be configured to cause processor 106 to invoke machine learning model 116 for processing data elements to determine predetermined data labels and/or for processing perturbed data elements to generate output data labels. In some embodiments, adversarial attack module 114 may be configured to store data (e.g., data elements, perturbed data elements, etc.) received from networked devices (e.g., remote computing devices and/or remote computing systems) in storage device 110.

In some embodiments, adversarial attack module 114 may include a software module (e.g., a module invoked by processor 106 based on program code executed by processor 106) such that functionalities of adversarial attack module 114 may be accessed via an API and such that adversarial attack module 114 may be packaged into a single unit (e.g., a single unit of reusable program code) that may be easily deployed and/or shared. In some embodiments, adversarial attack module 114 may include a combination of hardware and software (e.g., a processor configured to perform specific functions) such that adversarial attack module 114 may perform functions and share data and/or commands with processor 106. Adversarial attack module 114 may include various functions that may cause processor 106 to interface with storage device 110 to store and/or retrieve data elements, perturbed data elements, predetermined data labels, output data labels, and other data. Adversarial attack module 114 may retrieve data from model storage device 110 and adversarial attack module 114 may transmit data to memory 108 via perturbation interface module 112.

In some embodiments, adversarial attack module 114 may generate a perturbed data element by applying a data perturbation with a PGD algorithm on at least one data element. For example, adversarial attack module 114 may be configured to cause processor 106 to generate a perturbed data element by applying a data perturbation with a projected gradient descent algorithm on at least one data element. In some embodiments, adversarial attack module 114 may generate a perturbed data element by applying a PGD algorithm to at least one data element, where the PGD algorithm attacks the at least one data element by applying a perturbation to the at least one data element. In some embodiments, adversarial attack module 114 may input the perturbed data element to machine learning model 116 to generate an output data label. The perturbed data element may be associated with a predetermined data label, where the predetermined data label may be generated based on inputting a data element (e.g., the data element associated with the perturbed data element) to machine learning model 116.

In some embodiments, processor 106 may receive input instructions (e.g., via input from a user) to input a data element to machine learning model 116, which may be stored in storage device 110 and/or memory 108 of cycle detection system 102. Upon processing the input instructions, processor 106 may invoke adversarial attack module 114 to generate a perturbed data element by applying a data perturbation with a PGD algorithm on at least one data element.

Machine learning model 116 may include a machine learning model (e.g., a neural model, neural network, and/or the like). Machine learning model 116 may include a trained neural network that produces predetermined data labels and/or output data labels. In some embodiments, machine learning model 116 may receive at least one data element as input for generating a predetermined data label. In some embodiments, machine learning model 116 may receive at least one perturbed data element as input for generating an output data label. In some embodiments, machine learning model 116 may include plural machine learning models 116, where at least one machine learning model 116 includes a trained machine learning model. In some embodiments, machine learning model 116 may be trained to perform tasks, such as classification of data elements, or other machine learning tasks. Machine learning model 116 may be stored in storage device 110 and may be executed by processor 106 via software instructions and/or data structures stored in memory 108.

As shown in FIG. 1, cycle detection system 102 (e.g., processor 106 thereof) may perform various functions based on processor 106 being configured to execute program code that, when executed, will cause processor 106 to execute perturbation interface module 112 (e.g., program code for perturbation interface module 112) and adversarial attack module 114 (e.g., program code for adversarial attack module 114). In some embodiments, processor 106 may execute perturbation interface module 112 and adversarial attack module 114 as program code. Alternatively, processor 106 may execute perturbation interface module 112 and adversarial attack module 114 by communicating with a first hardware module corresponding to perturbation interface module 112 and communicating with a second hardware module corresponding to adversarial attack module 114, where perturbation interface module 112 and adversarial attack module 114 are configured with first program code and second program code, respectively.

Cycle detection system 102 (e.g., processor 106 thereof) may iteratively execute functions including executing a PGD algorithm for adversarial attack 120, executing a machine learning model 122, extracting perturbation data 124, comparing an output data label with a predetermined data label 126, and reading memory for perturbation data 128. Additionally, cycle detection system 102 (e.g., processor 106 thereof) may execute functions including terminating execution of iterative functions 130. For example, cycle detection system 102 (e.g., processor 106 thereof) may iteratively generate a perturbed data element by applying a data perturbation with a projected gradient descent algorithm on at least one data element. Cycle detection system 102 may iteratively extract the data perturbation from the perturbed data element as perturbation data. Cycle detection system 102 may iteratively determine whether the perturbation data is present in memory 108. When the perturbation data is not present in memory 108, cycle detection system 102 may iteratively store the perturbation data in memory 108. Cycle detection system 102 may terminate the iterative execution upon confirming that the perturbation data is present in memory 108.

In some embodiments, cycle detection system 102 may evaluate a measure of model robustness for a machine learning model (e.g., machine learning model 116) based on the perturbation data stored in memory 108. For example, cycle detection system may use the perturbation data stored in memory 108 to estimate how robust machine learning model 116 is to adversarial attack. Cycle detection system 102 may measure model robustness by evaluating how often a machine learning model is “tricked” by perturbed data elements provided as input.

The number and arrangement of systems, hardware, and/or modules shown in FIG. 1 is provided as an example. There may be additional systems, hardware, and/or modules, fewer systems, hardware, and/or modules, different systems, hardware, and/or modules, or differently arranged systems, hardware, and/or modules than those shown in FIG. 1. Furthermore, two or more systems, hardware, and/or modules shown in FIG. 1 may be implemented within a single system, hardware, and/or module. A single system, hardware, and/or module shown in FIG. 1 may be implemented as multiple, distributed systems, hardware, and/or modules. Additionally, or alternatively, a set of systems, a set of hardware, and/or a set of modules (e.g., one or more systems, one or more hardware devices, one or more modules) of FIG. 1 may perform one or more functions described as being performed by another set of systems, another set of hardware, or another set of modules of FIG. 1.

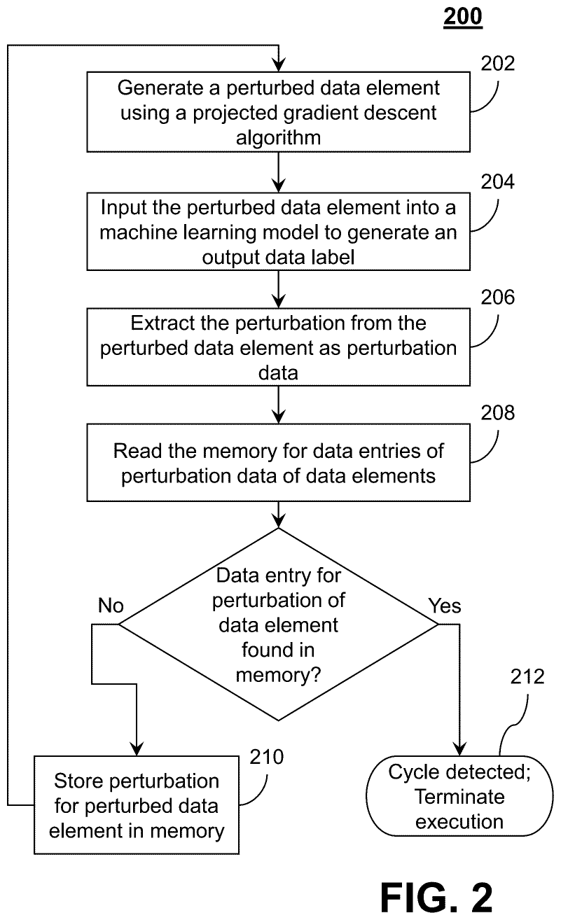

FIG. 2 shows a flow diagram of an exemplary method 200 for detecting cycles in adversarial attack of a data element based on storing perturbation data in memory as disclosed herein. In some embodiments, one or more of the functions described with respect to method 200 may be performed (e.g., completely, partially, etc.) by cycle detection system 102 (e.g., via processor 106). In some embodiments, one or more of the steps of method 200 may be performed (e.g., completely, partially, etc.) by another system, hardware, or module or a group of systems, hardware, or modules separate from or including cycle detection system 102, such as a client device and/or a separate computing device.

In some embodiments, one or more of the steps of method 200 may be performed in a training phase. A training phase may include a computing environment where a machine learning model, such as a neural model, is being trained (e.g., training environment, model building phase, and/or the like). In some embodiments, one or more of the steps of method 200 may be performed in a testing phase. A testing phase may include a computing environment where a machine learning model, such as a neural model, is being tested and/or evaluated (e.g., testing environment, model evaluation, model validation, and/or the like). In some embodiments, one or more of the steps of method 200 may be performed in a runtime phase. A runtime phase may include a computing environment where a machine learning model, such as a neural model, is active (e.g., deployed, accessible as a service, etc.) and is capable of generating runtime signal outputs (e.g., runtime predictions) based on runtime inputs.

As shown in FIG. 2, at step 202, method 200 may include generating a perturbed data element using a PGD algorithm. For example, cycle detection system 102 (e.g., processor 106 thereof) may generate a perturbed data element by applying a data perturbation with a PGD algorithm on at least one data element. The perturbed data element may be associated with (e.g., may have) a predetermined data label. The predetermined data label may be generated by machine learning model 116 by inputting the data element (e.g., the original data element before the data element has a data perturbation applied with the PGD algorithm) to machine learning model 116. That is, machine learning model 116 may generate the predetermined data label as an output (e.g., a signal output representing a prediction) based on the data element being provided as an input to machine learning model 116. In this way, machine learning model 116 may determine a predetermined data label for the data element before the data element is perturbed with a data perturbation. The predetermined data label may be associated with the data element and may remain associated with the perturbed data element after the original data element has been perturbed. The predetermined data label may represent a classification label of the original data element before perturbation.

In some embodiments, the PGD algorithm may be defined by:

$${δ}^{( i )} = {𝒫}_{β} ( {δ}^{( i - 1 )} + α sign ( {∇}_{X} ( ℒ ( f ( X + {δ}^{( i - 1 )} ) , y ) ) ) ,$$

where δ is the data associated with perturbations, i is an iteration counter, [symbol] is a projection function where [symbol] ={δ: ∥δ∥_{∞}≤∈}, ∈ is a radius, α is a step size, ∇ₓ is a gradient of X and sign is a sign of the gradient, X is the at least one data element or the perturbed data element, y is the predetermined data label, and [symbol] is a differentiable loss function such that [symbol] (f(X), y) is loss of the at least one machine learning model, where y is the at least one machine learning model. In some embodiments, the step size a may include a fixed step size.

At step 204, method 200 may include inputting the perturbed data element into a machine learning model to generate an output data label. For example, cycle detection system 102 may input the perturbed data element to at least one trained machine learning model (e.g., machine learning model 116) to generate an output data label. The perturbed data element may be associated with (e.g., may have) the output data label. The output data label may be generated by machine learning model 116 by inputting the perturbed data element (e.g., the perturbed data element that is generated once the data element has a data perturbation applied with the PGD algorithm) to machine learning model 116. That is, machine learning model 116 may generate the output data label as an output (e.g., a signal output representing a prediction) based on the perturbed data element being provided as an input to machine learning model 116. In this way, machine learning model 116 may determine an output data label for the perturbed data element after the original data element has been perturbed with a data perturbation. The output data label may be associated with the perturbed data element and may remain associated with the perturbed data element. The output data label may represent a classification label of the perturbed data element after perturbation.

At step 206, method 200 may include extracting the data perturbation from the perturbed data element as perturbation data. For example, cycle detection system 102 (e.g., processor 106 thereof) may extract the data perturbation from the perturbed data element as perturbation data. The data perturbation may be extracted from the perturbed data element by processor 106 retrieving and/or copying data representing the data perturbation. The data representing the data perturbation may include perturbation data. Perturbation data may include a tensor δ.

At step 208, method 200 may include reading the memory for data entries of perturbation data of data elements. For example, cycle detection system 102 (e.g., processor 106 thereof) may read data entries of perturbation data in memory 108. In some embodiments, cycle detection system 102 may read a single data entries of perturbation data in memory 108. Alternatively, cycle detection system 102 may read plural data entries of perturbation data in memory 108 (e.g., via reading plural memory locations).

At step 210, method 200 may include storing a perturbation for the perturbed data element in memory. For example, cycle detection system 102 may store the perturbation data extracted from a perturbed data element in memory 108. In some embodiments, the perturbation data may be stored in memory 108 as a tensor (e.g., a tensor δ). In some embodiments, the perturbation data may be stored in memory 108 as a hash value of a tensor representing the perturbation data. Cycle detection system 102 may store the perturbation data in memory 108 when, as shown in FIG. 2, at step 208, cycle detection system 102 reads memory 108 for data entries of perturbation data and cycle detection system 102 determines that a most recent perturbation data (e.g., perturbation data extracted from a perturbed data element of a current iteration) is not present in memory 108 (e.g., has not been previously stored during previous iterations).

At step 212, method 200 may include detecting a cycle and terminating execution. For example, cycle detection system 102 may determine a cycle has occurred based on determining that the most recent perturbation data is stored in memory 108. Cycle detection system 102 may then terminate the iterative execution. In this way, cycle detection may determine, based on finding that perturbation data is already present in memory 108, that a cycle has occurred in the PGD algorithm, and cycle detection system 102 may the n terminate the PGD algorithm. Termination of the PGD algorithm may indicate that perturbation of a data element has converged (e.g., completed) such that further iterations of perturbations to a data (or a perturbed data element perturbed at a previous iteration) will not further perturb the data element. Thus, one may conclude that the perturbed data element at the final (e.g., terminated) iteration may be sufficient to “trick” a trained machine learning model such that an output data label is different from a predetermined data label for an original data element, before any perturbations were applied.

In some embodiments, cycle detection system 102 may evaluate a measure of model robustness for a machine learning model (e.g., machine learning model 116) based on the perturbation data stored in memory 108. For example, cycle detection system 102 may use the perturbation data stored in memory 108 to estimate how robust machine learning model 116 is to adversarial attack. Cycle detection system 102 may measure model robustness by evaluating how often a machine learning model is “tricked” by perturbed data elements provided as input.

Steps of method 200 may be performed in various orders and sequences and are not necessarily limited to being performed in the order shown in FIG. 2. Accordingly, steps of method 200 are not limited to any particular order and may be performed by various components, whether cycle detection system 102 is implemented on a single computing device or multiple, distributed computing devices. Steps of method 200 may also be performed by a single processor of cycle detection system 102 or by multiple processors of cycle detection system 102.

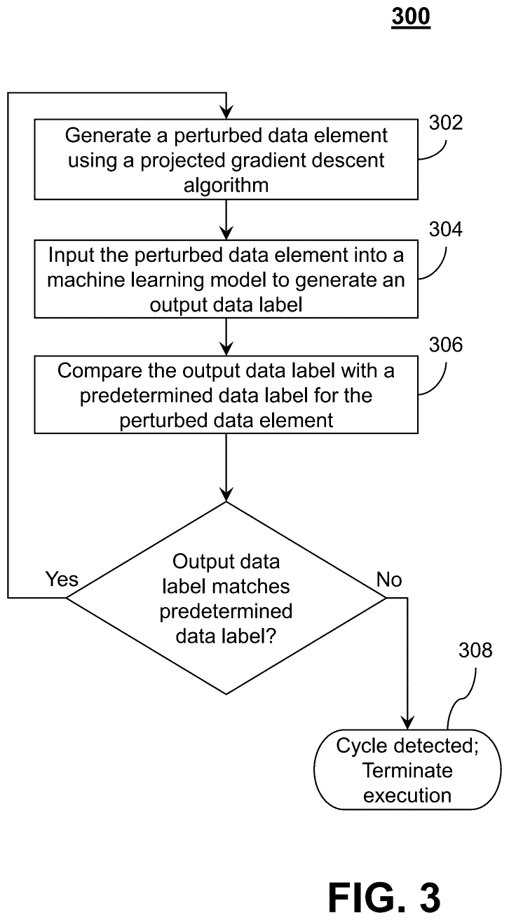

FIG. 3 shows a diagram of an exemplary method 300 for detecting cycles in adversarial attack of a data element based on determining whether a machine learning model is tricked by a perturbed data element as disclosed herein. In some embodiments, one or more of the functions described with respect to method 300 may be performed (e.g., completely, partially, etc.) by cycle detection system 102 (e.g., via processor 106). In some embodiments, one or more of the steps of method 300 may be performed (e.g., completely, partially, etc.) by another system, hardware, or module or a group of systems, hardware, or modules separate from or including cycle detection system 102, such as a client device and/or a separate computing device.

In some embodiments, one or more of the steps of method 300 may be performed in a training phase. A training phase may include a computing environment where a machine learning model, such as a neural model, is being trained (e.g., training environment, model building phase, and/or the like). In some embodiments, one or more of the steps of method 300 may be performed in a testing phase. A testing phase may include a computing environment where a machine learning model, such as a neural model, is being tested and/or evaluated (e.g., testing environment, model evaluation, model validation, and/or the like). In some embodiments, one or more of the steps of method 300 may be performed in a runtime phase. A runtime phase may include a computing environment where a machine learning model, such as a neural model, is active (e.g., deployed, accessible as a service, etc.) and is capable of generating runtime signal outputs (e.g., runtime predictions) based on runtime inputs.

As shown in FIG. 3, at step 302, method 300 may include generating a perturbed data element using a PGD algorithm. For example, cycle detection system 102 (e.g., processor 106 thereof) may generate a perturbed data element by applying a data perturbation with a PGD algorithm on at least one data element. The perturbed data element may be associated with (e.g., may have) a predetermined data label. The predetermined data label may be generated by machine learning model 116 by inputting the data element (e.g., the original data element before the data element has a data perturbation applied with the PGD algorithm) to machine learning model 116. That is, machine learning model 116 may generate the predetermined data label as an output (e.g., a signal output representing a prediction) based on the data element being provided as an input to machine learning model 116. In this way, machine learning model 116 may determine a predetermined data label for the data element before the data element is perturbed with a data perturbation. The predetermined data label may be associated with the data element and may remain associated with the perturbed data element after the original data element has been perturbed. The predetermined data label may represent a classification label of the original data element before perturbation.

In some embodiments, the PGD algorithm may be defined by:

$${δ}^{( i )} = {𝒫}_{β} ( {δ}^{( i - 1 )} + α sign ( {∇}_{X} ( ℒ ( f ( X + {δ}^{( i - 1 )} ) , y ) ) ) ,$$

where δ is the data associated with perturbations, i is an iteration counter, [symbol] is a projection function where [symbol] ={δ: ∥δ∥_{∞}≤∈}, ∈ is a radius, α is a step size, ∇ₓ is a gradient of X and sign is a sign of the gradient, X is the at least one data element or the perturbed data element, y is the predetermined data label, and [symbol] is a differentiable loss function such that [symbol] (f(X), y) is loss of the at least one machine learning model, where y is the at least one machine learning model. In some embodiments, the step size a may include a fixed step size.

At step 304, method 300 may include inputting the perturbed data element into a machine learning model to generate an output data label. For example, cycle detection system 102 may input the perturbed data element to at least one trained machine learning model (e.g., machine learning model 116) to generate an output data label. The perturbed data element may be associated with (e.g., may have) the output data label. The output data label may be generated by machine learning model 116 by inputting the perturbed data element (e.g., the perturbed data element that is generated once the data element has a data perturbation applied with the PGD algorithm) to machine learning model 116. That is, machine learning model 116 may generate the output data label as an output (e.g., a signal output representing a prediction) based on the perturbed data element being provided as an input to machine learning model 116. In this way, machine learning model 116 may determine an output data label for the perturbed data element after the original data element has been perturbed with a data perturbation. The output data label may be associated with the perturbed data element and may remain associated with the perturbed data element. The output data label may represent a classification label of the perturbed data element after perturbation.

At step 306, method 300 may include comparing the output data label with the predetermined data label for the perturbed data element. For example, cycle detection system 102 may compare the output data label to the predetermined data label associated with the perturbed data element to determine whether the output data label matches the predetermined data label. The predetermined data label (e.g., generated by machine learning model 116 based on providing the data element as input) may be associated with the perturbed data element. The output data label (e.g., generated by machine learning model 116 based on providing the perturbed data element as input) may also be associated with the perturbed data element. Such association may be a result of the data element (e.g., an original data element) being associated with the perturbed data element by virtue of the perturbed data element being similar to the data element, with a data perturbation applied. Thus, a predetermined data label may serve as a data label for the data element (e.g., an original data element) while the output data label may serve as a data label for the perturbed data element. In some embodiments, the predetermined data label and the output data label may be equivalent (e.g., the same). In this instance, it may be the case that the data perturbation applied to the data element was insufficient to “trick” machine learning model 116. In some embodiments, the predetermined data label may be different from the output data label. In this instance, it may be the case that the data perturbation applied to the data element was sufficient to “trick” machine learning model 116.

“Tricking” a machine learning model (e.g., machine learning model 116) may refer to causing a machine learning model to produce a different classification (e.g., a different output data label) from a previous classification (e.g., a predetermined data label) based on perturbing an original data element to generate a perturbed data element. The original data element, provided as input to the machine learning model, would generate a predetermined data label. The perturbed data element (e.g., the original data element with a data perturbation applied), provided as input to the machine learning model, would generate an output data label that is different form the predetermined data label. In this way, the machine learning model is said to be “tricked” because the data perturbation applied to the original data element caused the machine learning model to produce a different (and incorrect) classification label.

At step 308, method 300 may include detecting a cycle and terminating iterative execution. For example, cycle detection system 102 (e.g., processor 106 thereof) may terminate iterative execution upon confirming that the output data label does not match the predetermined data label associated with the perturbed data element. Cycle detection system 102 may compare the predetermined data label to the output data label to determine if machine learning model 116 was tricked or if machine learning model 116 correctly predicted a classification of the perturbed data element. Upon determining that machine learning model 116 was tricked (e.g., that the output data label does not match the predetermined data label), cycle detection system 102 may generate and/or transmit a signal to terminate execution of iterative steps of the PGD algorithm and/or iterative execution of method 300 described herein. In this way, cycle detection system 102 may determine, based on finding that the output data label matches the predetermined data label, that a cycle has occurred in the PGD algorithm, and cycle detection system 102 may then terminate the PGD algorithm. Termination of the PGD algorithm may indicate that perturbation of a data element has converged (e.g., completed) such that further iterations of perturbations to a data element (or a perturbed data element that was perturbed at a previous iteration) will not further perturb the data element. Thus, one may conclude that the perturbed data element at the final (e.g., terminated) iteration is sufficient to “trick” a trained machine learning model such that an output data label is different from a predetermined data label for an original data element, before any perturbations were applied. In some embodiments, if cycle detection system 102 determines that the output data label matches the predetermined data label (e.g., via a comparison operation), cycle detection system 102 may proceed to a next iteration of method 300 and/or the PGD algorithm, as shown in FIG. 3.

In some embodiments, cycle detection system 102 may evaluate a measure of model robustness for a machine learning model (e.g., machine learning model 116) based on the perturbation data stored in memory 108. For example, cycle detection system 102 may use the perturbation data stored in memory 108 to estimate how robust machine learning model 116 is to adversarial attack. Cycle detection system 102 may measure model robustness by evaluating how often a machine learning model is “tricked” by perturbed data elements provided as input.

Steps of method 300 may be performed in various orders and sequences and are not necessarily limited to being performed in the order shown in FIG. 3. Accordingly, steps of method 300 are not limited to any particular order and may be performed by various components, whether cycle detection system 102 is implemented on a single computing device or multiple, distributed computing devices. Steps of method 300 may also be performed by a single processor of cycle detection system 102 or by multiple processors of cycle detection system 102.

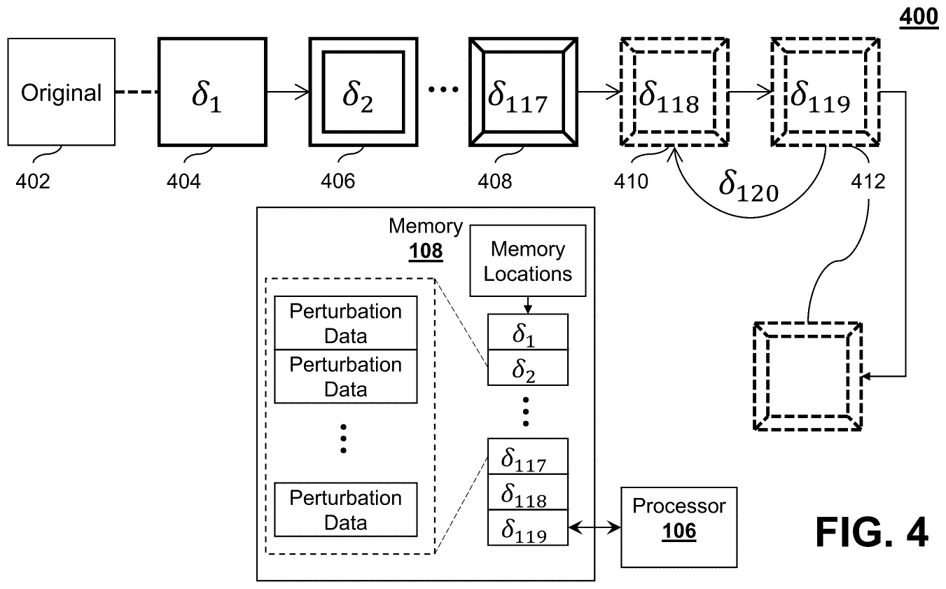

FIG. 4 shows a diagram of a data element undergoing adversarial attack (e.g., via a PGD algorithm) 400 with at least one cycle occurring as disclosed herein. As shown in FIG. 4, original data element 402 is provided to cycle detection system 102. Cycle detection system 102 may generate first perturbed data element 404 by applying a data perturbation with a PGD algorithm on original data element 402 at a first iteration. Cycle detection system 102 may iteratively execute the PGD algorithm to generate further perturbed data elements. For example, as shown in FIG. 4, cycle detection system 102 may generate second perturbed data element 406 by applying a data perturbation with a PGD algorithm on first perturbed data element 404 at a second iteration. Cycle detection system 102 may continue iterations of the PGD algorithm to further apply data perturbations to the perturbed data element (e.g., via successive iterations). Following further iterations of the PGD algorithm, cycle detection system 102 may generate one hundred seventeenth perturbed data element 408 by applying a data perturbation with a PGD algorithm on a previous perturbed data element (e.g., a one hundred sixteenth perturbed data element, not shown in FIG. 4) at a one hundred seventeenth iteration. Cycle detection system 102 may generate one hundred eighteenth perturbed data element 410 by applying a data perturbation with a PGD algorithm on one hundred seventeenth perturbed data element 408 at a one hundred eighteenth iteration. Cycle detection system 102 may generate one hundred nineteenth perturbed data element 412 by applying a data perturbation with a PGD algorithm on one hundred eighteenth perturbed data element 410 at a one hundred nineteenth iteration.

At each iteration, cycle detection system 102 may extract the data perturbation from the perturbed data element (e.g., first perturbed data element 404, second perturbed data element 406, one hundred seventeenth perturbed data element 408, one hundred eighteenth perturbed data element 410, one hundred nineteenth perturbed data element 412, and each previous and subsequent perturbed data element at other iterations) as perturbation data (e.g., first perturbation data δ₁, second perturbation data δ₂, one hundred seventeenth perturbation data δ₁₁₇, one hundred eighteenth perturbation data δ₁₁₈, one hundred nineteenth perturbation data δ₁₁₉, and each previous and successive perturbation data).

At each iteration, cycle detection system 102 may determine whether the perturbation data (e.g., first perturbation data δ₁, second perturbation data δ₂, one hundred seventeenth perturbation data δ₁₁₇, one hundred eighteenth perturbation data δ₁₁₈, one hundred nineteenth perturbation data δ₁₁₉, and each previous and successive perturbation data) is present in memory 108. When cycle detection system 102 determines the perturbation data is not present in memory 108, cycle detection system 102 may store the perturbation data in memory 108 (e.g., memory locations of memory 108 storing first perturbation data δ₁, second perturbation data δ₂, one hundred seventeenth perturbation data δ₁₁₇, one hundred eighteenth perturbation data δ₁₁₈, and one hundred nineteenth perturbation data δ₁₁₉, as shown in FIG. 4).

As shown in FIG. 4, cycle detection system 102 may terminate the iterative execution (e.g., of the PGD algorithm) upon confirming that perturbation data is present in memory 108. For example, at a next iteration, cycle detection system 102 may generate a one hundred twentieth perturbed data element by applying a data perturbation with a PGD algorithm on one hundred nineteenth perturbed data element 412 at a one hundred nineteenth iteration. Cycle detection system 102 may extract a one hundred twentieth data perturbation from the one hundred twentieth perturbed data element as one hundred twentieth perturbation data δ₁₂₀. Cycle detection system 102 may then determine that one hundred twentieth perturbation data δ₁₂₀ is already present in memory 108. As shown in FIG. 4, cycle detection system 102 determines that one hundred twentieth perturbation data δ₁₂₀ is already present in memory 108 as one hundred nineteenth perturbation data δ₁₁₉ (e.g., via reading memory 108). That is, in FIG. 4, one hundred twentieth perturbation data δ₁₂₀ is the same perturbation data as one hundred nineteenth perturbation data δ₁₁₉. As shown in FIG. 4, when cycle detection system 102 determines that one hundred twentieth perturbation data δ₁₂₀ is present in memory 108, cycle detection system 102 may determine that a cycle has occurred. Once cycle detection system 102 determines that a cycle has occurred, cycle detection system 102 may terminate the iterative execution (e.g., of the PGD algorithm). As shown in FIG. 4, cycle detection system 102, upon confirming that one hundred twentieth perturbation data δ₁₂₀ is present in memory 108 (e.g., as one hundred nineteenth perturbation data δ₁₁₉), cycle detection system 102 terminates iterative execution and determines that one hundred nineteenth perturbed data element 412 represents a final perturbed data element, such that the iterations have converged and further perturbations applied to one hundred nineteenth perturbed data element 412 will not adversarially alter one hundred nineteenth perturbed data element 412. Further iterations would thus be a waste of computing resources. Thus, termination of iterative execution may reduce computing resources and termination of iterative execution via cycle detection system 102 confirms that one hundred nineteenth perturbed data element 412 is a final perturbed data element that may be used (e.g., for testing, training, and/or the like) as input to machine learning model 116.

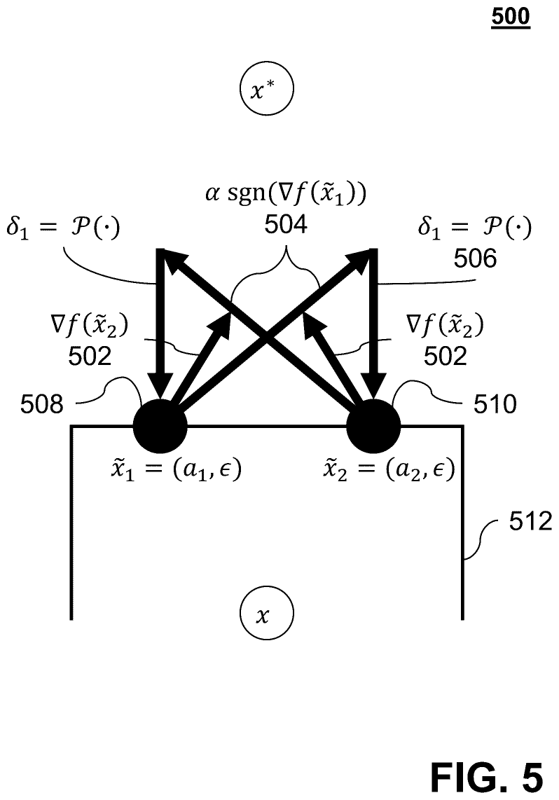

FIG. 5 shows a diagram of a two dimensional example of a visualization of a cycle 500 of two iterations occurring on a boundary of an L_{∞} ball. As shown in FIG. 5, cycle 500 may include gradient compute direction 502, calculation of PGD algorithm 504, projection [symbol] 506 back to feasible space, first cycle data perturbation 508, second cycle data perturbation 510, and L_{∞}ball boundary 512. In some embodiments, cycle detection system 102 may terminate iterative execution of a PGD algorithm upon detecting a cycle 500. As shown in FIG. 5, at each iteration, gradient compute direction 502 points in a local direction of steepest ascent of a loss function, and calculation of PGD algorithm 504 takes a sign of gradient compute direction 502. Cycle detection system 102 may execute calculation of PGD algorithm 504 as a vector given by a step size times the signed gradient compute direction 502 to determine a data perturbation as a point outside of L_{∞}ball boundary 512. Based on L_{∞}ball boundary 512 and the data perturbation being outside of L_{∞}ball boundary 512, cycle detection system 102 may project the data perturbation back to L_{∞}ball boundary 512 via projection [symbol] 506 back to feasible space. If cycle detection system 102 determines the data perturbation to be on a flat surface or edge of L_{∞}ball boundary 512, then calculation of PGD algorithm 504 can often be caught in a cycle of length two, perhaps perpetually chasing a local maximum outside of L_{∞}ball boundary 512, while data perturbations are determined as being stuck on L_{∞}ball boundary 512, as shown in FIG. 5. Thus, a cycle may cause calculation of PGD algorithm 504 to continually converge onto first cycle data perturbation 508 and/or second cycle data perturbation 510, causing repetitive calculations at subsequent iterations, allowing cycle detection system 102 to determine that cycling is occurring such that calculation of PGD algorithm 504 may be terminated.

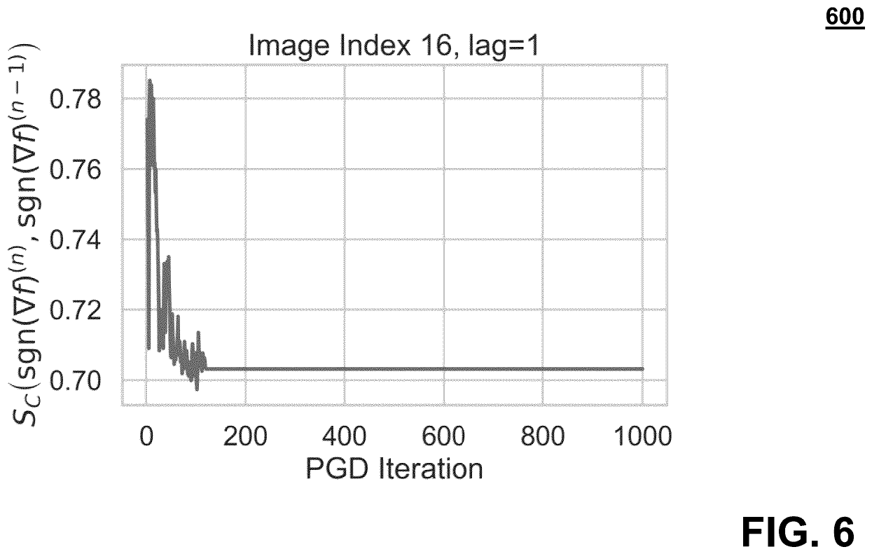

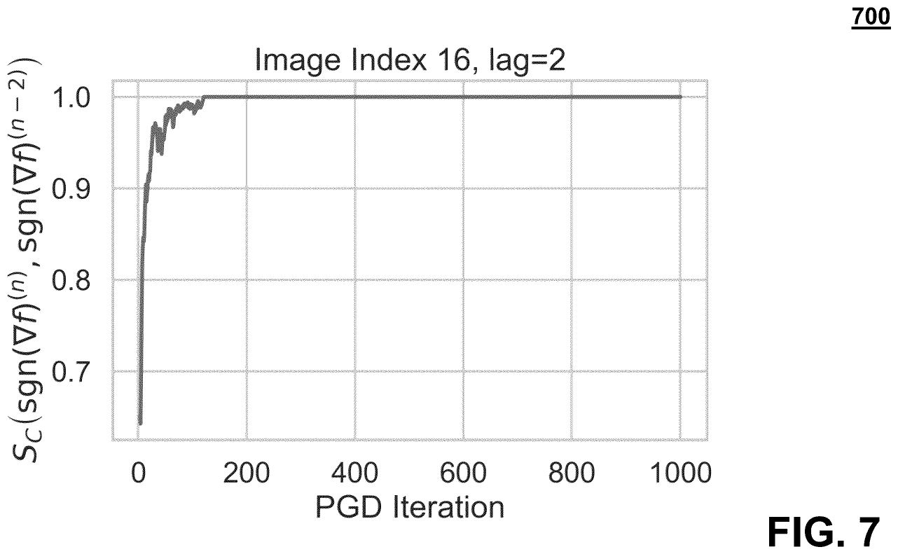

FIGS. 6 and 7 show an exemplary graph 600 and 700 displaying a value of a cosine similarity between successive signed gradients and every other signed gradient, respectively, for iterations of a PGD algorithm. As shown in FIG. 6, cycle detection system 102 may also detect cycles in a PGD algorithm by identifying when a cosine similarity of successive signed gradients converge to a constant value. FIG. 6 shows a cycle of length two that was encountered when running PGD on a trained machine learning model. After cycle detection system 102 executed sufficient PGD iterations and the PGD algorithm gets stuck in a cycle, a cosine similarity of successive signed gradients may be determined by cycle detection system 102 to converge to a value close to 0.7, thus indicating that the successive signed gradients are different from each other, but the same two signed gradients are always compared after enough PGD iterations have passed. Similarly, as shown in FIG. 7, a cosine similarity between every other signed gradient may be determined by cycle detection system 102 to converge to one, indicating that every other signed gradient is identical to one another after enough PGD iterations.

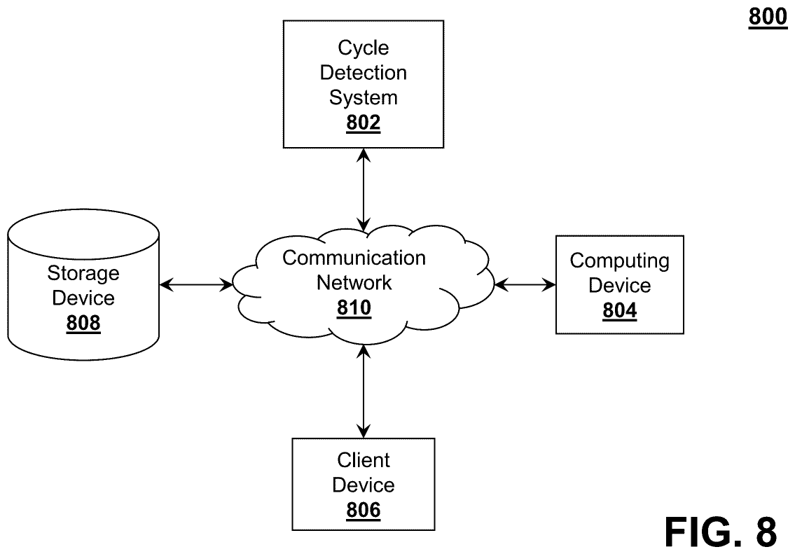

FIG. 8 shows a diagram of an exemplary system environment 800 for detecting cycles in adversarial attack of a data element as disclosed herein. The various components of FIG. 8 may be implemented in one or more computing devices (e.g., one or more servers, client devices, user devices, and/or the like) and the one or more computing devices may be connected via a communications network (e.g., the Internet). Each of the components shown in FIG. 8 are described in the context of an exemplary embodiment.

As shown in FIG. 8, embodiments relate to a system environment 800 configured for detecting cycles in adversarial attack of a data element in which devices, systems, methods, and/or products described herein may be implemented. System 800 may include cycle detection system 802, computing device 804, client device 806, storage device 808, and communication network 810. Cycle detection system 802, computing device 804, client device 806, and storage device 808 may interconnect (e.g., establish a connection to communicate, and/or the like) via wired connections, wireless connections, or a combination of wired and wireless connections.

Cycle detection system 802 may include one or more computing devices configured to communicate with computing device 804, client device 806, storage device 808 via communication network 810. In some embodiments, cycle detection system 802 may include one or more computing devices such as computing device 804, client device 806, and/or storage device 808. For example, cycle detection system 802 may include a group of computing devices 804 and/or other like devices. In some embodiments, cycle detection system 802 may be associated with (e.g., operated by) computing device 804 and/or client device 806, as described herein. In some embodiments, cycle detection system 802 may be the same as or similar to cycles detection system 102.

Cycle detection system 802 may be implemented in a single computing device or computing node. Cycle detection system 802 may be implemented in one or more computing devices (e.g., a group of servers, such as a group of computing devices or computing nodes, and/or the like) as a distributed and/or decentralized system such that software instructions and/or machine learning models are implemented on different computing devices or computing nodes. In some embodiments, cycle detection system 802 may be associated with a local computing device, such that cycle detection system 802 is executed on the local computing device or part of cycle detection system 802 is executed on the local computing device as part of a distributed and/or decentralized computing system. Alternatively, cycle detection system 802 may include at least one local computing device executing software instructions for detecting cycles in adversarial attack of a data element.

Computing device 804 may include one or more computing devices, such as processors, storage devices, and/or similar computer components that communicate with cycle detection system 802 and/or client device 806 and/or other computing devices over a network, such as the Internet or private networks and, in some examples, facilitate communication among other computing devices 804 and/or client devices 806. In some embodiments, computing device 804 may implement cycle detection system 802 and/or execute machine learning model 116. In some embodiments, computing device 804 may include one or more devices capable of receiving information and/or communicating information to cycle detection system 802, client device 806, and/or storage device 808 via communication network 810. For example, computing device 804 may include a computing device, such as a server, a group of servers, and/or other like devices. In some embodiments, computing device 804 may be associated with a server, a client device, and/or a computing device as described herein.

Client device 806 may include one or more computing devices configured to communicate with cycle detection system 802, computing device 804, and/or storage device 808 via communication network 810. For example, client device 806 may include a desktop computer (e.g., a client device that communicates with a server), a mobile device, and/or the like. In some embodiments, client device 806 may be associated with a user (e.g., an individual operating client device 806). Client device 806 may access a service (e.g., a cloud service, software-as-a-service, and/or the like) such as cycle detection system 802 to remotely execute a PGD for performing adversarial attack on a data element, and/or for detecting cycles in adversarial attack of a data element.

Data storage device 808 may include a database and/or registry for storing one or more machine learning models, one or more data elements, one or more perturbed data elements, one or more predetermined data labels, and/or one or more output data labels. In some embodiments, data storage device 808 may include a storage device internal to a computing device (e.g., computing device 804). Data storage device 808 may be configured to communicate with cycle detection system 802, computing device 804, and/or client device 806 via communication network 810. Data storage device 808 may include a device storing data that is accessible by cycle detection system 802, computing device 804, and/or client device 806. For example, data storage device 808 may store data elements, perturbed data elements, perturbation data, predetermined data labels, and/or output data labels. Storage device 808 may be updated with new and/or updated data elements, perturbed data elements, perturbation data, predetermined data labels, and/or output data labels received from cycle detection system 802.

Communication network 810 may include one or more wired and/or wireless networks. For example, communication network 810 may include a cellular network (e.g., a long-term evolution (LTE®) network, a third generation (3G) network, a fourth generation (4G) network, a fifth generation (5G) network, a code division multiple access (CDMA) network, and/or the like), a local area network (LAN), a wide area network (WAN), a metropolitan area network (MAN), a private network (e.g., a private network associated with cycle detection system 802), an ad hoc network, an intranet, the Internet, a fiber optic-based network, a cloud computing network, and/or the like, and/or a combination of these or other types of networks.

The number and arrangement of systems, hardware, and/or devices shown in FIG. 8 is provided as an example. There may be additional systems, hardware, and/or devices, fewer systems, hardware, and/or devices, different systems, hardware, and/or devices, or differently arranged systems, hardware, and/or devices than those shown in FIG. 8. Furthermore, two or more systems, hardware, and/or devices shown in FIG. 8 may be implemented within a single system, hardware, and/or device. A single system, hardware, and/or device shown in FIG. 8 may be implemented as multiple, distributed systems, hardware, and/or devices. Additionally, or alternatively, a set of systems, a set of hardware, and/or a set of devices of FIG. 8 may perform one or more functions described as being performed by another set of systems, another set of hardware, or another set of devices of FIG. 8.

Any of the processors disclosed herein may include any integrated circuit or other electronic device (or collection of devices) capable of performing an operation on at least one instruction, which may include a Reduced Instruction Set Core (RISC) processor, a CISC microprocessor, a Microcontroller Unit (MCU), a CISC-based CPU, a DSP, a GPU, a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor may include one or more processing or operating modules. A processing or operating module may be a software or firmware operating module configured to implement any of the functions disclosed herein. The processing or operating module may be embodied as software and stored in memory; the memory being operatively associated with the processor. A processing module may be embodied as a web application, a desktop application, a console application, etc.

The processor may include or be associated with a computer or machine readable medium. The computer or machine readable medium may include memory. Any of the memory discussed herein may be computer readable memory configured to store data. The memory may include a volatile or non-volatile, transitory or non-transitory memory, and be embodied as an in-memory, an active memory, a cloud memory, etc. Examples of memory may include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory may be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium may be configured to store one or more instructions thereon. The instructions may be in the form of algorithms, program logic, etc. that cause the processor to execute any of the functions disclosed herein.

Embodiments of the memory may include a processor module and other circuitry to allow for the transfer of data to and from the memory, which may include to and from other components of a communication system. This transfer may be via hardwire or wireless transmission. The communication system may include transceivers, which may be used in combination with switches, receivers, transmitters, routers, gateways, wave-guides, etc. to facilitate communications via a communication approach or protocol for controlled and coordinated signal transmission and processing to any other component or combination of components of the communication system. The transmission may be via a communication link. The communication link may be electronic-based, optical-based, opto-electronic-based, quantum-based, etc. Communications may be via Bluetooth, near field communications, cellular communications, telemetry communications, Internet communications, etc.

Data stored in the exemplary computing device (e.g., in the memory) may be stored on any type of suitable computer readable media, such as optical storage (e.g., a compact disc, digital versatile disc, Blu-ray disc, etc.), magnetic tape storage (e.g., a hard disk drive), or solid-state drive. An operating system may also be stored in the memory.

In an exemplary embodiment, the data may be configured in any type of suitable database configuration, such as a relational database, a structured query language (SQL) database, a distributed database, an object database, etc. Suitable configurations and storage types will be apparent to persons having skill in the relevant art.

The exemplary computing device may also include a communications interface. The communications interface may be configured to allow software and data to be transferred between the computing device and external devices. Exemplary communications interfaces may include a modem, a network interface (e.g., an Ethernet card), a communications port, a PCMCIA slot and card, etc. Software and data transferred via the communications interface may be in the form of signals, which may be electronic, electromagnetic, optical, or other signals as will be apparent to persons having skill in the relevant art. The signals may travel via a communications path, which may be configured to carry the signals and may be implemented using wire, cable, fiber optics, a phone line, a cellular phone link, a radio frequency link, etc. Transmission of data and signals may be via transmission media. Transmission media may include coaxial cables, copper wire, fiber optics, etc. Transmission media may also take the form of acoustic or light waves, such as those generated during radio-wave and infrared data communications, or other form of propagated signals (e.g., carrier waves, digital signals, etc.).

Memory semiconductors (e.g., DRAMs, etc.) may be means for providing software to the computing device. Computer programs (e.g., computer control logic) can be stored in the memory. Computer programs may also be received via the communications interface. Such computer programs, when executed, may enable computing device to implement the present methods as discussed herein. In particular, the computer programs stored on a non-transitory computer-readable medium, when executed, may enable hardware processor device to implement the methods as discussed herein. Accordingly, such computer programs may represent controllers of the computing device.

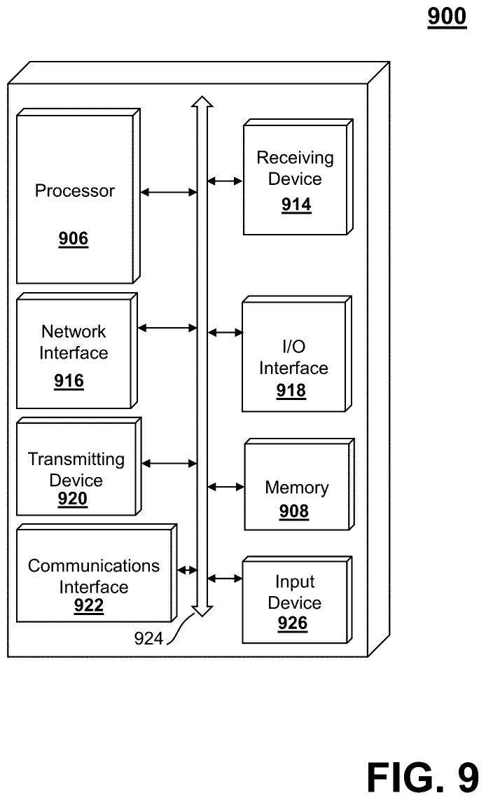

FIG. 9 shows a diagram of example components of a computing device or system 900 as disclosed herein. Computing device 900 (and/or at least one component of computing device 900) may correspond to at least one of cycle detection system 102, processor 106, memory 108, and/or storage device 110 in FIG. 1 and/or at least one of cycle detection system 802, computing device 804, client device 806, storage device 808, and/or communication network 810 in FIG. 8. In some embodiments, such systems or devices in FIGS. 1, 4, and 8 may include at least one computing device 900 and/or at least one component of computing device 900. The number and arrangement of components shown in FIG. 9 are provided as an example. In some embodiments, computing device 900 may include additional components, fewer components, different components, or differently arranged components than those shown in FIG. 9. Additionally, or alternatively, a set of components (e.g., one or more components) of computing device 900 may perform one or more functions described as being performed by another set of components of computing device 900.

Computing system or device 900 may include processor 906, memory 908, receiving device 914, network interface 916, input/output (I/O) interface 918, transmitting device 920, communications interface 922, communication infrastructure 924, and input device 926. Memory 908 may be the same as or similar to memory 108 as disclosed herein. Processor 906 may be the same as or similar to processor 106 as disclosed herein. Communications infrastructure 924 may be the same as or similar to communication network 810.

Memory 908 may be configured for storing program code for at least one machine learning model. Memory 908 may include one or more memory devices such as volatile or non-volatile memory. For example, the volatile memory may include random access memory. According to exemplary embodiments, the non-volatile memory may include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 900 via a mobile communication network. According to an exemplary embodiment, an external memory device may be used in place of any resident memory devices. Data stored in system 900 may be stored on any type of suitable computer readable media, such as optical storage (e.g., a compact disc, digital versatile disc, Blu-ray disc, etc.) or magnetic tape storage (e.g., a hard disk drive). The stored data may include network traffic data, log data, streaming events, and/or CDRs generated and/or accessed by processor 906, and software or program code used by processor 906 for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

Receiving device 914 may be a combination of hardware and software components configured to receive data samples from the mobile network or database. According to exemplary embodiments, receiving device 914 may include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 914 may be an input device for receiving signals and/or data samples formatted according to 3GPP protocols and/or standards. Receiving device 914 may be connected to other devices via a wired or wireless network or via a wired or wireless direct link or peer-to-peer connection without an intermediate device or access point. The hardware and software components of receiving device 914 may be configured to receive the data from the mobile network according to one or more communication protocols and data formats. For example, receiving device 914 may be configured to communicate over a network, which may include a LAN, a WAN, a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, receiving device 914 may be configured to identify parts of the received data via a header and parse the data signal and/or data packet into small frames (e.g., bytes, words) or segments for further processing at processor 906.

Processor 906 may be configured for executing the program code stored in memory 908. Upon execution, the program code causes processor 906 to perform the functions at a node on the mobile communication network or remote computing device (e.g., server, computer, etc.) of the user and execute a machine learning model (e.g., machine learning model 116) for detecting cycles in a PGD algorithm for adversarial attack on local computing devices or remote computing devices according to the exemplary embodiments described herein. Processor 906 may be a special purpose or a general purpose computing device encoded with program code or software for performing the exemplary functions and/or features disclosed herein. According to exemplary embodiments of the present disclosure, processor 906 may include a CPU. The CPU may be connected to the communications infrastructure including a bus, message queue, or network, multi-core message-passing scheme, for communicating with other components of computing system 900, such as memory 908, input device 926, communications interface 922, and I/O interface 918. The CPU may include one or more processors such as a microprocessor, microcomputer, programmable logic unit or any other suitable hardware computing devices as desired.

I/O interface 918 may be configured to receive the signal from processor 906 and generate an output suitable for a peripheral device via a direct wired or wireless link. I/O interface 918 may include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 920 may be configured to receive data from processor 906 and assemble the data into a data signal and/or data packets according to the specified communication protocol and data format of a peripheral device or remote device to which the data is to be sent. Transmitting device 920 may include any one or more of hardware and software components for generating and communicating the data signal over communications infrastructure 924 and/or via a direct wired or wireless link to a peripheral or remote device. Transmitting device 920 may be configured to transmit information according to one or more communication protocols and data formats as discussed in connection with receiving device 914.

According to exemplary embodiments described herein, memory 908 and processor 906 can store and/or execute computer program code for performing the specialized functions described herein. It should be understood that the program code may be stored on a non-transitory computer usable medium, such as memory devices for the system 900 (e.g., computing device), which may be memory semiconductors (e.g., DRAMs, etc.) or other tangible non-transitory means for providing software to system 900. The computer programs (e.g., computer control logic) or software may be stored in memory devices (e.g., device memory 908) resident on/in system 900. The computer programs may also be received from external storage devices and/or network storage locations via a communications interface. Such computer programs, when executed, may enable system 900 to implement the present methods and exemplary embodiments discussed herein. Accordingly, such computer programs may represent controllers of system 900. Where the present disclosure is implemented using software, the software may be stored in a computer program product or non-transitory computer readable medium and loaded into system 900 using any one or combination of a removable storage drive, an interface for internal or external communication, and a hard disk drive, where applicable.

In the context of exemplary embodiments of the present disclosure, a processor may include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling system 900 to perform the functions disclosed herein. It will be apparent to persons having skill in the relevant art that such processes result in system 900 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A computing system for detecting cycles in adversarial attack of a data element, the computing system comprising:
memory configured to include storage locations to store data elements and perturbation data; and
a processor configured with an adversarial attack module, the processor configured with program code that, when executed, will cause the processor to iteratively execute:
generating a perturbed data element by applying a data perturbation with a projected gradient descent algorithm on at least one data element;
extracting the data perturbation from the perturbed data element as perturbation data;
determining whether the perturbation data is present in the memory, and when the perturbation data is not present in the memory, storing the perturbation data in the memory; and
terminating the iterative execution upon confirming that the perturbation data is present in the memory.

2. The computing system of claim 1, wherein the iterative execution includes a maximum iteration value, such that the processor will automatically terminate the iterative execution when the maximum iteration value of the iterative execution is performed by the processor.

3. The computing system of claim 1, wherein the program code will cause the processor to iteratively execute:
inputting the perturbed data element to at least one trained machine learning model to generate an output data label;
comparing the output data label to a predetermined data label associated with the perturbed data element to determine whether the output data label matches the predetermined data label; and
terminating the iterative execution upon confirming that the output data label does not match the predetermined data label associated with the perturbed data element.

4. The computing system of claim 1, wherein the projected gradient descent algorithm is defined by:
$${δ}^{( i )} = {𝒫}_{β} ( {δ}^{( i - 1 )} + α sign ( {∇}_{X} ( ℒ ( f ( X + {δ}^{( i - 1 )} ) , y ) ) ) ,$$
where δ is the data associated with perturbations, i is an iteration counter, [symbol] is a projection function where [symbol] ={δ: ∥δ∥_{∞}≤∈}, ∈ is a radius, α is a step size, □ₓ is a gradient of X and sign is a sign of the gradient, X is the at least one data element or the perturbed data element, y is the predetermined data label, and [symbol] is a differentiable loss function such that [symbol] (f(X), y) is loss of the at least one machine learning model, where y is the at least one machine learning model.

5. The computing system of claim 4, wherein the step size a is a fixed step size.

6. The computing system of claim 1, wherein the program code will cause the processor to evaluate a measure of model robustness for the at least one machine learning model based on the perturbation data stored in the memory.

7. The computing system of claim 1, wherein the perturbation data stored in the memory are stored as a hash of a tensor representing the perturbation data.

8. A computing system for detecting cycles in adversarial attack of a data element, the computing system comprising:
memory configured to include storage locations to store data elements and perturbation data; and
a processor configured with an adversarial attack module, the processor configured with program code that, when executed, will cause the processor to iteratively execute:
generating a perturbed data element by applying a data perturbation with a projected gradient descent algorithm on at least one data element, the perturbed data element having a predetermined data label;
inputting the perturbed data element to at least one trained machine learning model to generate an output data label;
comparing the output data label to the predetermined data label; and
terminating iterative execution upon confirming that the output data label does not match the predetermined data label.

9. The computing system of claim 8, wherein the iterative execution includes a maximum iteration value, such that the processor will automatically terminate the iterative execution when the maximum iteration value of the iterative execution is performed by the processor.

10. The computing system of claim 8, wherein the program code will cause the processor to iteratively execute:
extracting the data perturbation from the perturbed data element as perturbation data;
determining whether the perturbation data is present in the memory, and when the perturbation data is not present in the memory, storing the perturbation data in the memory; and
terminating the iterative execution upon confirming that the perturbation data is present in the memory.

11. The computing system of claim 8, wherein the projected gradient descent algorithm is defined by:
$${δ}^{( i )} = {𝒫}_{β} ( {δ}^{( i - 1 )} + α sign ( {∇}_{X} ( ℒ ( f ( X + {δ}^{( i - 1 )} ) , y ) ) ) ,$$
where δ is the data associated with perturbations, i is an iteration counter, [symbol] is a projection function where [symbol] ={δ: ∥δ∥_{∞}≤∈}, ∈ is a radius, α is a step size, ∇ₓ is a gradient of X and sign is a sign of the gradient, X is the at least one data element or the perturbed data element, y is the predetermined data label, and [symbol] is a differentiable loss function such that [symbol] (f(X), y) is loss of the at least one machine learning model, where y is the at least one machine learning model.

12. The computing system of claim 11, wherein the step size a is a fixed step size.

13. The computing system of claim 10, wherein the program code will cause the processor to evaluate a measure of model robustness for the at least one machine learning model based on the perturbation data stored in the memory.

14. The computing system of claim 10, wherein the perturbation data stored in the memory are stored as a hash of a tensor representing the perturbation data.

15. A computer-implemented method for detecting cycles in adversarial attack of a data element, the method comprising:
iteratively executing:
generating, with at least one processor, a perturbed data element by applying a projected gradient descent algorithm to at least one data element, wherein the projected gradient descent algorithm attacks the at least one data element by applying a data perturbation to the at least one data element;
inputting the perturbed data element, the perturbed data element having a predetermined data label, to at least one trained machine learning model to generate an output data label;
comparing, with the at least one processor, the output data label with the predetermined data label;
extracting the data perturbation from the perturbed data element as perturbation data;
reading, with the at least one processor, data entries of perturbation data in the memory;
wherein, when the perturbation data is not stored in the memory and the output data label matches the predetermined data label:
storing, with the at least one processor, the perturbation data in the memory; and
continuing, with the at least one processor, the iterative execution; or
wherein, when the perturbation data is stored in the memory or the output data label does not match the predetermined data label:
determining a cycle has occurred and terminating, with the at least one processor, the iterative execution.

16. The method of claim 15, wherein the iterative execution includes a maximum iteration value, such that the at least one processor will automatically terminate the iterative execution when a number of iterations is performed by the at least one processor reaches the maximum iteration value.

17. The method of claim 15, wherein the projected gradient descent algorithm is defined by:
$${δ}^{( i )} = {𝒫}_{β} ( {δ}^{( i - 1 )} + α sign ( {∇}_{X} ( ℒ ( f ( X + {δ}^{( i - 1 )} ) , y ) ) ) ,$$
where δ is the data associated with perturbations, i is an iteration counter, [symbol] is a projection function where [symbol] ={δ: ∥δ∥_{∞}≤∈}, ∈ is a radius, α is a step size, ∇ₓ is a gradient of X and sign is a sign of the gradient, X is the at least one data element or the perturbed data element, y is the predetermined data label, and [symbol] is a differentiable loss function such that [symbol] (f(X), y) is loss of the at least one machine learning model, where y is the at least one machine learning model.

18. The method of claim 17, wherein the step size a is a fixed step size.

19. The method of claim 15, including evaluating, with the at least one processor, a measure of model robustness for the at least one machine learning model based on the perturbation data stored in the memory.

20. The method of claim 15, wherein the perturbation data stored in the memory are stored as a hash of a tensor representing the perturbation data.
